(19) United States
(12) Patent Application Publication
(10) Pub. No.: US 2008/0122229 A1
(43) Pub. Date: May 29, 2008

(54) Device for locking door of tray for vehicle

(75) Inventors: Ho Sik Choi, Gyeonggi-do (KR); Young Ki Oh, Gyeonggi-do (KR)

Correspondence Address: EDWARDS ANGELL PALMER & DODGE LLP, P.O. BOX 55874, BOSTON, MA, 02205, US

(73) Assignees: Huyndai Motor Company, Seoul (KR); Hyundai Mobis Co., Ltd., Seoul (KR)

(21) Appl. No.: 11/707,808

(22) Filed: Feb. 15, 2007

(30) Foreign Application Priority Data
Nov. 24, 2006 (KR) 10-2006-0117148

(51) Int. Cl. E05C 3/06

(52) U.S. Cl. 292/216

(57) ABSTRACT

The present invention relates to a device for locking a door of a tray for a vehicle, comprising: an operation button in a push-open type which is formed to be separated from the door and is integrated with a tray cover of the tray; a rotating structure which performs a rotating operation in response to a linear operation of the operation button; and a latch which is configured to be able to be locked to or released from a locking groove of the door in response to the rotating operation of the rotating structure.

### CROSS-REFERENCE TO RELATED APPLICATION

This application claims priority to and the benefit of Korean Patent Application No. 10-2006-0117148 filed in the Korean Intellectual Property Office on Nov. 24, 2006, the entire contents of which are incorporated herein by reference.

### BACKGROUND OF THE INVENTION

(a) Field of the Invention

The present invention relates to a device for locking a door of a tray for a vehicle, and more particularly to a device for locking a door of a tray for a vehicle in which an operation button is disposed at a tray assembly and manipulation force of a latch can be regulated separately from manipulation force of an operation button when the tray is being closed, so as to enhance sensitive quality and maximize amount of overlap of the latch, thereby enhancing credibility of the locking operation.

(b) Background Art

Generally, a tray is provided at a cabin of a vehicle in order to provide an ease of an occupant, and an example of the tray includes an ashtray for cigarette butts and cigarette ash and a cup holder for receiving a cup.

In addition, recently, a CD tray for containing CDs is provided.

The tray is generally provided at a center fascia of an instrument panel, and a cover is rotatably connected to a front portion thereof so as to open and close an inner space of the tray.

That is, the door closes the inner space of the tray while not being used, and the door opens the inner space of the tray while being used so that things contained in the tray can be easily drawn out. Accordingly, ease in use can be enhanced, and an external appearance is fine.

As shown in FIG. 5, in a conventional method for fixing a door of a tray, a locking device for regulating movement of a door 200 inside a tray 100 is used, and an example of the locking device is a latch 120.

That is, the latch 120 is provided at an inside of the tray 100, and an operation button 210 which endows rotation force to the latch 120 so as to open or close the tray 100 is provided to the door 200.

However, although the conventional locking device is simple, it is difficult to function well in a small space. Since a linear motion of the operation button 210 is regulated only by a rotating motion of the latch 120, amount of overlap of the latch 120 can be limited, which can violate a performance requirement by relevant regulations.

Furthermore, since a torsion spring 130 which endows elastic force for returning the latch 120 to its original position also serves return function of the latch 120, there is a problem in that force for closing the tray 100 can be increased in proportion to the manipulation force of the operation button 210.

Still furthermore, as shown in FIG. 6, since the door locking structure is assembled to a center fascia which is the counterpart part instead of being integrally assembled to the tray 100, there are difficulties in sensitive quality of the product and dimension management of parts in case that there is an assembly tolerance.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to provide a device for locking a door of a tray for a vehicle in which an operation button is disposed at a tray assembly and manipulation force of a latch can be regulated separately from manipulation force of an operation button when the tray is being closed, so as to enhance sensitive quality and maximize amount of overlap of the latch, thereby enhancing credibility of the locking operation.

In one aspect, the present invention provides a device for locking a tray door for a vehicle, comprising: an operation button in a push-open type which is formed to be separated from the door and is integrated with a tray cover of the tray; a rotating structure which performs a rotating operation in response to a linear operation of the operation button; and a latch which is configured to be able to be locked to or released from a locking groove of the door in response to the rotating operation of the rotating structure.

Preferably, the rotating structure may include: a rotating part to both sides of which a torsion spring is fitted; a vertical operation part which is supported by the torsion spring and closely adheres to the operation button; and a hooking part which is formed to be protruded in a direction corresponding to an operation direction of the operation button.

The torsion spring may preferably include a circular elastic part at a center thereof and a supporting part which is extended from the circular elastic part and is elastically supported by a fixing part 150 and a rotating part 12 (rotating structure) of a counterpart part 12, 150.

Suitably, the torsion spring can be formed in a pair and the supporting parts can be connected to one another so as to form a single body.

Preferably, a latch cover can mounted on the latch. The latch cover may be provided with an insertion hole. To the hole is inserted a projection formed at an upper portion of the latch so as to limit an operation range of the latch.

Also preferably, a return spring for use only for returning the latch is disposed between the latch and the latch cover. By this arrangement, manipulation force of the latch can be regulated separately from manipulation force of the operation button. Also, amount of overlap of the latch can be enhanced.

In a preferred embodiment, the latch may be provided with a receiving groove which is designed to be perpendicular to the hooking part of the rotating structure to receive the hooking part. By rotation of the hooking part, the latch can move vertically.

In such embodiment, a latch cover which is provided with an insertion hole to which a projection formed at an upper portion of the latch so as to limit an operation range of the latch is inserted may suitably be mounted on the latch.

Also suitably, a return spring for use only for returning the latch which can regulate manipulation force of the latch separately from manipulation force of the operation button and at the same time can enhance amount of overlap of the latch may be disposed between the latch and the latch cover.

### BRIEF DESCRIPTION OF THE DRAWINGS

The present invention will be better understood from reading the description which follows, given by way of non-limiting example, with reference to the attached drawings.

FIG. 1 is an exploded perspective view of a device for locking a door of a tray for a vehicle according to an exemplary embodiment of the present invention.

FIG. 2 is a perspective view of a device for locking a door of a tray for a vehicle according to an exemplary embodiment of the present invention.

FIG. 3 is a side sectional view of a device for locking a door of a tray for a vehicle according to an exemplary embodiment of the present invention.

FIG. 4 is a side sectional view of a device for locking a door of a tray for a vehicle according to an exemplary embodiment of the present invention after operation.

FIG. 5 is a side sectional view of a conventional device for locking a door of a tray for a vehicle.

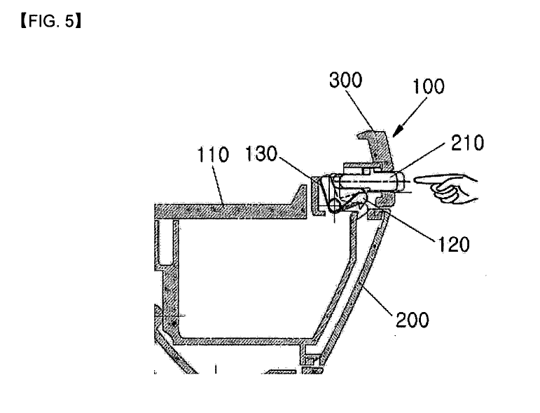

FIG. 6 is a drawing showing a conventional tray which is assembled to a center fascia.

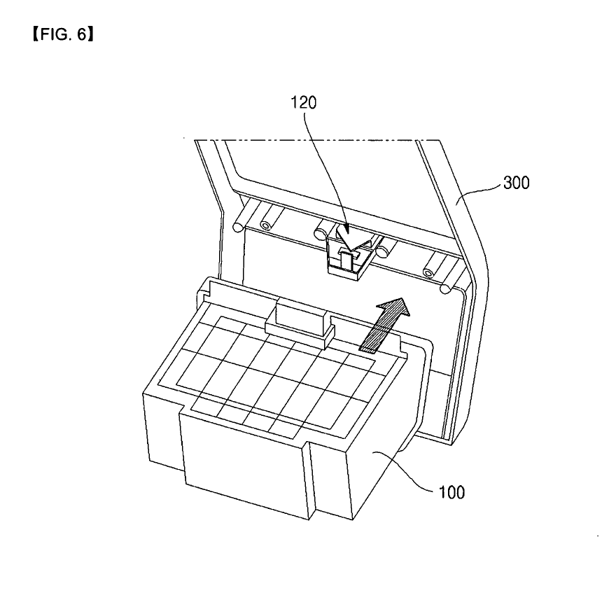

Reference numerals set forth in the Drawings includes reference to the following elements as further discussed below:

| | |
|---|---|
| 10: locking means | 11: operation button |
| 12: rotating structure | 12a: rotating part |
| 12b: vertical operation part | 12c: hooking part |
| 13: latch | 13a: receiving groove |
| 13b: projection | 14: latch cover |
| 14a: insertion hole | 15: torsion spring |
| 15a: circular elastic part | 15b: supporting part |
| 15c: connecting part | 16: return spring |
| 20: locking groove | |

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

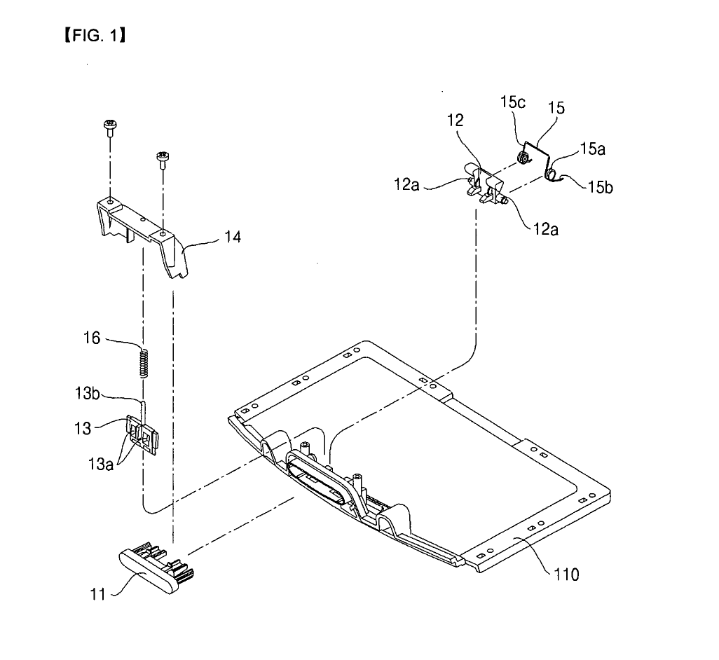

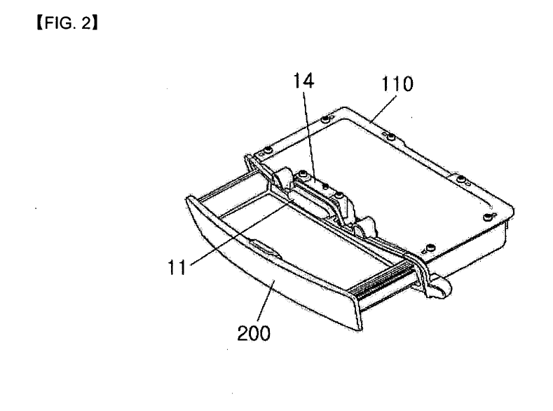

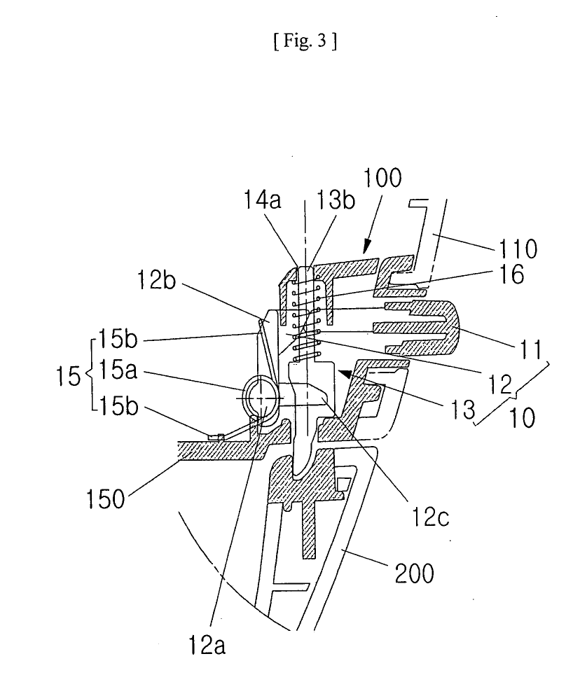

FIG. 1 is an exploded perspective view of a device for locking a door of a tray for a vehicle according to an exemplary embodiment of the present invention, FIG. 2 is a perspective view of a device for locking a door of a tray for a vehicle according to an exemplary embodiment of the present invention, and FIG. 3 is a side sectional view of a device for locking a door of a tray for a vehicle according to an exemplary embodiment of the present invention.

As shown in FIG. 1 to FIG. 3, a tray 100 which is installed to a center fascia or the like of an instrument panel of a vehicle is configured to receive various things therein.

A door 200 is hingedly connected to an opening of the tray 100 so as to open and close an inner space of the tray 100. In order to control an operation of the door 200, an operation button 11 and a locking means 10 are provided. More specifically, an operation button 11 is in a push-open type and is integrated to a tray cover 110 of the tray 100 at an upper side of the door 200. A locking means 10 includes an operation part which performs a locking operation of a latch 13 in response to operation of the operation button 11 and the latch 13.

Since the operation button 11 is integrated with the tray cover 110 of the tray 100, difficulties in sensitive quality of the product and dimension management of part can be overcome even when there is an assembly tolerance.

The operation button 11 of the locking means 10 is configured to realize a horizontal linear motion, that is, a push operation. A rotating structure 12 is provided to an operation side of the operation button 11. The rotating structure 12 contacts the operation button 11 and is rotated by the push operation of the operation button 11.

The rotating structure 12 includes rotating parts 12a to both sides of which a circular elastic part 15a of a torsion spring 15 is fitted, a vertical operation part 12b which is supported by a connecting part 15c which is disposed at a side of the torsion spring 15 and closely adheres to the operation button 11, and a hooking part 12c which is formed to be protruded in a direction corresponding to an operation direction of the operation button 11.

At this time, the torsion spring 15 includes the circular elastic part 15a at a center thereof and a supporting part 15b which is extended from the circular elastic part 15a and is elastically supported by a fixing part 150 and a rotating part 12 (rotating structure) of a counterpart part 12, 150. In a preferred embodiment of the present invention, the torsion spring 15 can be formed in a pair and the supporting parts 15b are connected to one another by connecting part 15c so as to form a single body.

Accordingly, an elastic force can be increased, compared to that case that the single torsion spring 15 is used.

A receiving groove 13a is formed to receive the hooking part 12c of the rotating structure 12 therein, and the latch 13 which moves in a vertical direction and is separated from a locking groove 20 in case that the hooking part 12c of the rotating structure 12 rotates is provided.

The latch 13 is arranged to be perpendicular to the hooking part 12c of the rotating structure 12, and the latch 13 is configured to undergo a linear motion by the rotation of the rotating structure 12.

That is, in case that the rotating structure 12 rotates by the push operation of the operation button 11, the latch 13 receiving the hooking part 12c therein moves upwardly, thereby releasing the locked door 200.

At this time, a latch cover 14 which is configured to limit an operation range of the latch 13 is mounted to an upper part of the latch 13. An insertion hole 14a to which a bar-shaped projection 13b formed at an upper part of the latch 13 is inserted is formed in the latch cover 14.

As such, a return spring 16 for use only for returning the latch is disposed at the projection 13b between the latch cover 14 and the latch 13.

By this arrangement, push power of the operation button 11 can be released so that manipulation force of the latch 13 can be separately regulated from manipulation force of the operation button 11 when the door 200 of the tray 100 is closed by the locking means 10. As a result, sensitive quality can be enhanced and amount of overlap of the latch 13 can be increased, thereby maximizing credibility of locking performance.

That is, the returning operation of the operation button 11, the rotating structure 12 and the latch 13 is realized by the torsion spring 15 which is supported by the rotating structure 12, and the return spring 16 adds additional elastic force to the latch 13 so as to realize the above-mentioned effect.

Accordingly, in a normal state, the latch 13 is fitted into the locking groove 20 which is formed at an upper part of the door 200 so that an inner space of the tray 100 is closed by the door 200. In a state that the operation button 11 is pushed for use, the latch 13 is separated from the locking groove 20 so that the door 200 is opened.

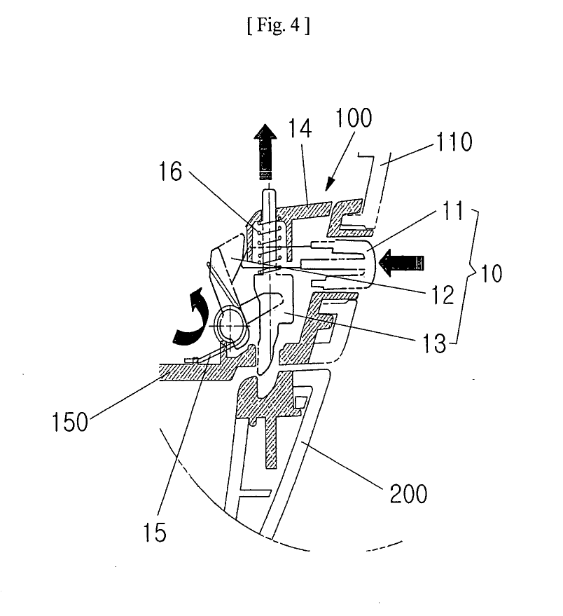

That is, as shown in FIG. 4, when the operation button 11 which is provided at an upper side of the tray cover 110 is pushed, the rotating structure 12 rotates relative to the rotating part 12a to which the torsion spring 15 is fixed so that the hooking part 12c rotates in an upper direction, and the latch 13 receiving this by the receiving groove 13a moves in an upward direction along the insertion hole 14a of the latch cover 14 so as to be separated from the locking groove 20.

The door 200 having been separated from the latch 13 rotates forwardly so as to be opened. If a user upwardly rotates the door 200 so as to close the door 200, the latch 13 can be fitted into the locking groove 20 so that an inner space of the tray 100 is closed.

As described above, according to a device for locking a tray door for a vehicle according to the present invention, the locking performance of the door locking system of a tray can be enhanced in a limited space so as to meet performance requirements by relevant regulation, and sensitive quality can be enhanced.

In addition, since the operation button is provided to the tray, difficulties in sensitive quality of the product and dimension management of parts can be overcome even when there is an assembly tolerance.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A device for locking a door of a tray for a vehicle, comprising:
a push-open type operation button which is formed to be separated from the door and is to be integrated with a tray cover of the tray;
a rotating structure which performs a rotating operation in response to a linear operation of the operation button; and
a latch which is configured to be able to be locked to or released from a locking groove of the door in response to the rotating operation of the rotating structure.

2. The device of claim 1, wherein the rotating structure comprises:
a rotating part having one side and the other side along it rotating axis to both sides of which a torsion spring is fitted:
a vertical operation part which is supported by the torsion spring and closely adheres to but is separate from the operation button; and
a hooking part which is formed to be protruded in a direction corresponding to operation direction of the operation button.

3. The device of claim 2, wherein the torsion spring comprises a circular elastic part at a center thereof and a supporting part which is extended from the circular elastic part and is elastically supported by a fixing part and a vertical operation part (rotating structure).

4. The device of claim 3, wherein the torsion spring is formed in a pair and the supporting parts are connected to one another so as to form a single body.

5. The device of claim 2, wherein the latch is provided with a receiving groove which is perpendicular to the hooking part of the rotating structure and receives the hooking part so as to move vertically by rotation of the hooking part.

6. The device of claim 1, wherein a latch cover is mounted on the latch, the latch being provided with an insertion hole to which a projection formed at an upper portion of the latch is inserted such that the latch is movable in a vertical direction as the protrusion is being inserted through the insertion hole, so as to limit an operation range of the latch.

7. The device of claim 6, wherein a return spring for use only for returning the latch is disposed between the latch and the latch cover, the return spring being capable of regulating manipulation force of the latch separately from manipulation force of the operation button and at the same time can enhance amount of overlap of the latch.

8. The device of claim 5, wherein a latch cover which is provided with an insertion hole to which a projection formed at an upper portion of the latch so as to limit an operation range of the latch is inserted is mounted on the latch.

9. The device of claim 8, wherein a return spring for use only for returning the latch is disposed between the latch and the latch cover, the return spring being capable of regulating manipulation force of the latch separately from manipulation force of the operation button and at the same time enhancing an amount of overlap of the latch.
